(19) United States
(12) Patent Application Publication
(10) Pub. No.: US 2006/0155439 A1
(43) Pub. Date: Jul. 13, 2006

(54) System and method for using a vehicle's key to collect vehicle data and diagnose mechanical problems, to store and compare security data to allow only authorized use of vehicles and a method to automatically set vehicle features usng the key

(76) Inventors: John Andrew Slawinski, Richmond, VA (US); Timothy Chris Mitchell, Richmond, VA (US)

Correspondence Address: John Slawinski, 3437 Gayton Meadows Terrace, Richmond, VA, 23233, US

(21) Appl. No.: 11/033,562

(22) Filed: Jan. 12, 2005

(51) Int. Cl. G01M 17/00

(52) U.S. Cl. 701/35; 701/33; 701/29

(57) ABSTRACT

A method for collecting, storing, interpreting and transmitting data from vehicles of all kinds allowing vehicle users and fleet managers to diagnose problems using the IntelaKey System, to transmit vehicle feature settings to on board vehicle computers, store and analyze vehicle operating data, recognize who the driver is at any particular time, transmit vehicle data to mechanical support personnel, record trip information and track vehicle maintenance. In addition, the IntelaKey System may be used for business in conjunction with accounting and dispatch software, and GPS systems to track hours for both billing and payroll purposes and travel routes for management of personnel efficiency. Daily work schedules, routes and work orders may be loaded on the IntelaKey for access via handheld or small personal computer by businesses or government field personnel. Governments may collect data from many IntelaKey Systems and users to analyze traffic patterns and vehicle emissions data.

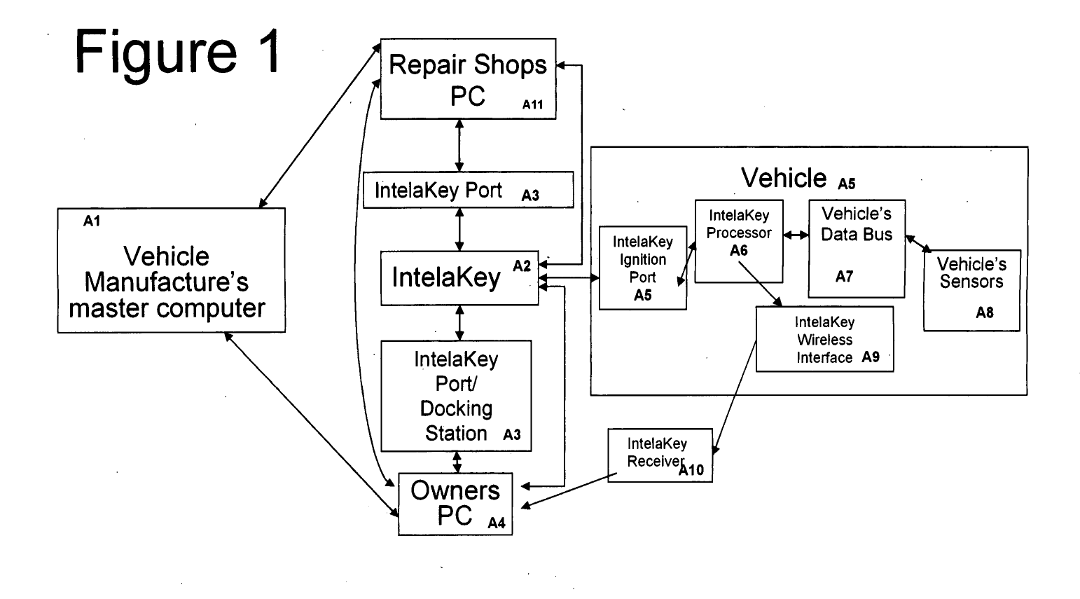

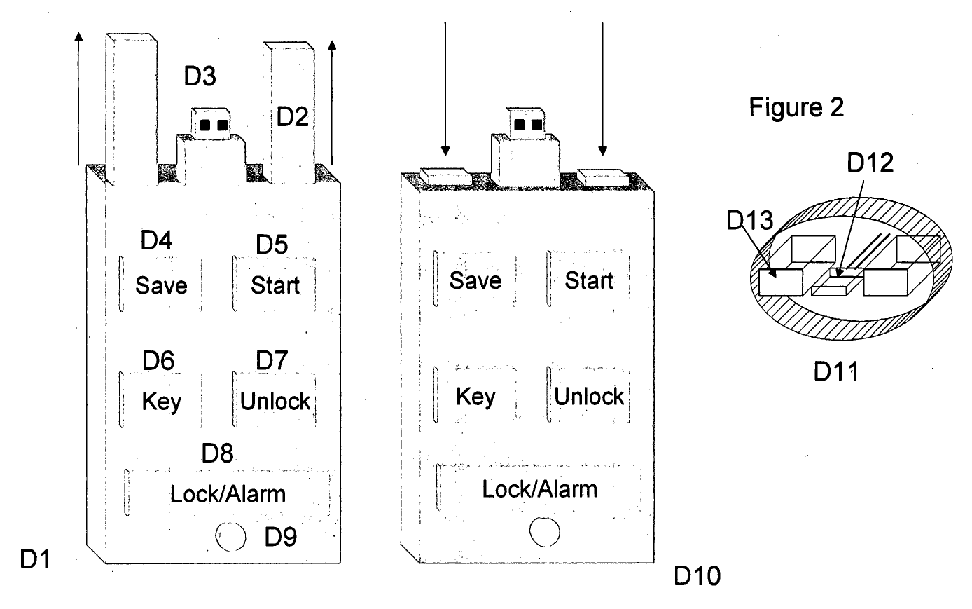

### CROSS-REFERENCE TO RELATED APPLICATOINS

Not Applicable

### STATEMENT REGARDING FEDERALLY SPONSORED RESEARCH OR DEVELOPMENT

Not Applicable

### REFERENCE TO SEQUENCE LISTING, A TABLE OR COMPUTER LISTING COMPACT DISC APPENDIX

Not Applicable

### BACKGROUND OF THE INVENTION

Currently vehicle and fleet management data is collected manually and either entered on paper forms or recorded in fleet management computer programs. Problems are reported to mechanics as a result of a noticed difference in driving performance based on the driver's perceptions, the appearance of warning lights on the dash board or based on miles traveled since the last service. When a vehicle reaches the repair shop a mechanic attaches a diagnostic computer to the vehicles computer to determine problems or uses experience to determine what the problem may be. However, many times vehicle problems are difficult to diagnose because of a lack of information and that the specific problem is not occurring while the vehicle is in the repair shop.

Vehicle care with regards to fluid levels is also accomplished by observation, either with the help of gauges or with visual inspection. Drivers check the mileage since the last oil change, watch the gas gauge, run out of window washer fluid, overheat the engine when the radiator drains and stresses the transmission when the transmission fluid is not at optimum levels. Drivers and fleet managers resort to keeping manual logs, on paper or computer, of service dates and mileages to determine when oil and other liquids should be cheeked, changed or topped off. This system is inefficient and carries the risk of being inaccurate potentially causing undo harm to vehicles. This manual method also takes much time to manage properly. Fleet management software is available; however, the user must still collect and enter data manually.

The IntelaKey records all important service data after each vehicle use then writes that data to a PC when downloaded. A software program then analyzes the data and, if appropriate at that time, recommends particular services that should be performed.

At this time, large consumer and commercial service companies and even governments and municipalities rely on time cards to determine employees' hours for a pay period. This information is entered into the companies accounting system manually consuming time and providing opportunity for inaccuracies. In addition personnel efficiency while in the field is calculated manually and based on perceptions and second hand knowledge of the tasks field personnel must perform. In addition employee's assignments, service tickets and routes are provided on paper work orders or service tickets.

Currently fleet managers use GPS radio tracking systems to ensure proper job performance by personnel at great expense. The current systems are not integrated into fleet systems that track maintenance or other vehicle data. This leaves fleet managers with multiple programs and data collection devices to use and maintain.

A fleets vehicle keys are stored in lock boxes and provide fleet managers no automated verification of a particular keys status.

At this time, the only historical information available about a vehicle is information stored by the mechanics shop or manually written or entered into a computer for review. This approach is time consuming, cumbersome and awkward.

For the individual or family using vehicles with features such as seat settings, mirror settings and radio settings this is accomplished by manually setting each feature or, in some high-end models, by pressing user buttons to change settings. This takes time and does not always result in a user setting features consistently.

### BRIEF SUMMARY OF THE INVENTION

Today, personal vehicles, fleets, motorcycles, aircraft and boats are maintained using a manual or computer log system and by manually checking fluid levels, odometers and gauges requiring each user or fleet manager to inspect each vehicle, recording appropriate information or by using manufacturer supplied hardware and software to access the vehicles computers and uploading maintenance data. They track items such as: mileage, oil level, fuel level, tire pressure and keep records of service done to each vehicle. An individual or fleet manager relies on educated guesses, mileage and reported problems to determine when a vehicle requires service. A user also uses a number of dashboard warning lights to indicate when a vehicle is experiencing difficulty or needs fluids service.

The IntelaKey System automates these processes by making vehicle information fast and easy to transport from the vehicle to the mechanic and to the home PC. The IntelaKey user may analyze data collected from the vehicle on an IntelaKey and determine if service is required, review a drivers driving style, program a particular drivers performance settings to control young drivers or barrowers or review trip information

In addition employees using fleet vehicles log time and attendance manually by using time clocks or hand written time cards and driving logs to verify work time, routes and other pay and task information. Service technicians are dispatched with a combination of scheduling software and paper work orders and use maps to determine driving routes and locations of service calls.

With the IntelaKey system fleet managers and service managers may review service call duration, travel time, routes and the vehicles performance to better manage personnel and vehicles.

Today, there is no way to determine the driving style used on a vehicle returned for trade-in or determine the service history of a vehicle being sold as used or one returned to a vehicle rental company. Used vehicle buyers are left to inspect service tickets, receipts and hand written reports, if they exist, and the vehicle itself before purchase. No indisputable information is available to the purchaser or seller to determine a fair value for the vehicle.

The IntelaKey System allows sellers and buyers to fairly determine vehicle performance and service records so a vehicle's fair value may be determined by using IntelaKey historical data files.

Currently any individual with the car's key may start and use a vehicle even if it is not their vehicle. IntelaKey may force a driver to enter a “combination” on the digital radio before engaging the transmission or may require fingerprint identification.

Vehicle users must take their vehicle to a mechanic to diagnose a vehicle's problems. This is done through an existing data output terminal with the mechanics diagnostic computer and the mechanics knowledge and experience.

With IntelaKey a vehicle may be diagnosed remotely or from the IntelaKey itself. Parts could be ordered prior to having the vehicle on site at the mechanics shop or delivered based on the IntelaKey data transmitted over the internet.

Car rental companies have no way to determine a renter's driving habits. IntelaKey collects driving style information allowing fleet managers and car rental companies to better determine rates for their rentals.

Municipalities must put vehicle counters on streets to gather data on traffic volumes and patterns. By collecting IntelaKey data from many vehicles governments would increase information about driving and traffic patterns.

Insurance companies must rely on witnesses and police reports to determine liability. In addition all drivers with unblemished records receive the same insurance rates no matter what their driving habits or style. IntelaKey data could be used to analyze accidents to determine vehicle speeds, deceleration, g-force and other data to add to accident information to help determine cause and liability.

Today there is no way to automatically record the operator of a vehicle at any particular time. IntelaKey increases the likelihood that a driver is authorized and that the vehicle records the authorized users information.

### TECHNICAL FIELD

This invention is a vehicle ignition key, a security device, a diagnostic and management system using an IntelaKey (car key), an IntelaKey Ignition Switch, an onboard vehicle computer and memory (IntelaKey Processor), and IntelaKey PC software or other compatible software. In addition, the IntelaKey System provides a vehicle diagnostic system and method enabling vehicle diagnoses by collecting data from a vehicles computers and sensors then storing the information on an IntelaKey and then reading the collected data using a PC computer program. In addition, drivers may use IntelaKey data to set driver comfort features inside the vehicle. Also, the system will report user trip information including travel routes and time, in conjunction with the system clock, a GPS system and map information, user driving style information based on acceleration rates, RPMs attained during acceleration, G-forces measured via sensors and mathematical calculations, breaking speed, time log both elapsed including stops and actual driving time and allow for performance setting manipulation.

### DETAILED DESCRIPTION OF THE INVENTION

This invention, the IntelaKey System, includes an on board vehicle computer (IntelaKey Processor), an IntelaKey ignition port, an IntelaKey, an IntelaKey Docking Station and IntelaKey Software running on a PC. It addresses and solves all the above mentioned issues automatically, efficiently and simply. The system provides the following features:
1. Convenience: The use of the IntelaKey System allows users to set individual features automatically and start the car remotely.
2. Safety: The IntelaKey System ensures a properly maintained vehicle and may limit the performance capabilities of a vehicle.
3. Maintenance Management: The IntelaKey and IntelaKey Software watches and reports on service issues and stores historical maintenance records.
4. Efficiency: The IntelaKey System loads, stores and transmits data simply with the use of a PC, software and USB or other storage interface technology.
5. Security: The IntelaKey Processor requires the VIN number, a user assignable security code, and a vehicle security code be transmitted from the IntelaKey and may require a digital combination be sent from the digital radio to drive the vehicle.
6. Research: IntelaKey data may be used by manufacturers to diagnose manufacturing problems.
7. Employee Tracking: The IntelaKey System in conjunction with a GPS system and a clock may be used to track vehicle routes, call duration and employee time. In conjunction with the IntelaKey Docking Station monitors a keys use.
8. Employee Dispatch and routing: An IntelaKey in conjunction with IntelaKey Software, a handheld, or other personal computing device and dispatch software program allows dispatchers to upload daily assignments, routes, service tickets, payloads and other job information to be viewed via personal computing device, onboard monitor or printed with an onboard printer.
9. Driver Analysis: The IntelaKey System can analyze driving styles by recording data from g-force sensors, tachometers, speedometers, odometer, brakes and the clock.
10. Vehicle Value: The IntelaKey System improves resale values by providing buyers with detailed information about the vehicles use and information about the vehicles maintenance.
11. Performance: The IntelaKey System improves vehicle performance with timely maintenance and the ability of an IntelaKey user to change the mechanical performance settings on particular engine components.
12. Accuracy: The IntelaKey System records actual data without manual input so it is completely accurate.
13. Traffic Pattern Analysis: By using data from many IntelaKey Systems and when used in many vehicles in a jurisdiction the IntelaKey data may provide vast amounts of traffic pattern information.
14. Environment: The IntelaKey System better maintains vehicle efficiency and allows users to monitor, store and send and store emissions data for use by governments, manufacturers and users.

In more detail, the IntelaKey System provides a method for drivers to check a vehicles liquids and monitor replacement periods and be alerted when fluid maintenance is required or the vehicle needs to be taken to a repair shop. Collecting and storing output data of various mechanical and electronic devices such as sensors, engine control unit, transmission control unit, and to use the IntelaKey Data collected to diagnose vehicle problems on-line and off-line by using the stored data, analyzing the data and notifying the users of the analyzed results by executing a PC compatible program.

In addition, the IntelaKey System is a vehicle maintenance system that provides mechanics with data that they can read on a PC and a vehicle diagnostic program that systematically analyzes the data uploaded to a PC and makes maintenance recommendations then stores maintenance activities in the IntelaKey.

Another application of the IntelaKey is for vehicle manufacturers. They may collect vehicle maintenance data from service facilities on-line through the IntelaKey and a PC collecting software module and use unit specific data to diagnose manufacturing and design problems. This will allow manufacturers to enhance future models making them more reliable.

In addition the IntelaKey System provides drivers with a safer and more comfortable driving experience. Features such as radio settings, seat settings, steering wheel settings, mirror settings, performance and driving style settings may be loaded into a vehicle upon inserting the IntelaKey in the. Each driver's own settings will be stored in their IntelaKey and may be revised anytime desired by resetting a specific feature while in the vehicle and confirming with the press of a button the new setting. Performance settings allows parents, fleet managers and others with IntelKey Master Code Access to the settings program to control the top end speed and acceleration ability of vehicles making, for example safer driving for teens.

The system for collecting and diagnosing vehicle data comprises an IntelaKey which is connected to the IntelaKey Ignition. The IntelaKey has all vehicle-related data including basic vehicle information and vehicle maintenance information. The IntelaKey USB key port is hard-wired to the IntelaKey Processor and includes a processor to filter and pass either direction the appropriate data between it and the On Board Data Bus.

The IntelaKey carries the VIN number and owner specific data including user security codes. Security is enhanced with a fingerprint reader on the surface of the IntelaKey that is compared to the fingerprint data stored on the vehicles main processor. Additional security includes a digital combination lock for ignition where the digital radio transmits left, right, left radio station tuning data that when properly dialed releases the ignition for start. The IntelaKey also carries vehicle password, and fields for name, address, phone and e-mail.

The IntelaKey also holds user specific comfort settings which are output either at insertion of the IntelaKey or when the user presses the remote (radio) door release or remote ignition button on the IntelaKey. Either of these actions then causes the vehicles main processor to send signals to the appropriate controllers for adjustment of seats and other comfort, performance and safety features.

Further, the IntelaKey Processor used in the system includes a vehicle interface for use with existing vehicles and connects to the On Board Digital Connector which is usually under the steering column of vehicles or connects at time of vehicle manufacture to the vehicles data bus. This interface will gather and prepare data from the IntelaKey to input user data to the vehicle and to retrieve operating data from the vehicles Electronic Control Modules and other onboard computers. The system uses industry standard operating software. Both the IntelaKey and the IntelaKey Control Unit will have compatible file systems to store and transfer data. Files include but are not limited to user data, vehicle specific data such as VIN number, trouble codes and operating parameters, security data such as user access codes, combination lock radio codes, fingerprint data and vehicle security code, maintenance data, repair data, trip data such as time duration and route, service call information such as customer address, time of call route to take, telephone number and nature of service request and files to collect data for manufacturer and government research. The IntelaKey Control Unit has a micro processor to execute programs associated with data retrieval analysis and storage.

The system uses a standard USB port to interface a PC with the IntelaKey. When the IntelaKey is inserted into a PC's USB port software then stores data, analyzes the data, makes service recommendations and changes data on the IntelaKey with appropriate password and, among other things, transfers and reports data to other programs or other computers either intranet or internet. In addition the IntelaKey Software may be used to change operating information and user data stored on the IntelaKey.

The IntelaKey System may also include an IntelaKey Docking Station which holds multiple IntelaKeys, downloads and uploads IntelaKey data via a PC, and monitors the physical presence of the IntelaKey.

In addition to interfacing with a PC the IntelaKey System may also be interfaced with a Palm Pilot or other hand held computer which has IntelaKey Palm Software installed. The hand held computer is able to provide all the maintenance report information and change security data and any other data utilization process that may be done on a PC.

We claim:

1. A vehicle key system, the IntelaKey System, for collecting and storing, driver, trip and vehicle data for the purpose of securing the vehicle, setting driver preferences, storing current GPS and mapping trip data, analyzing trip information and diagnosing maintenance requirements, comprising:
a. A vehicle USB key (the IntelaKey) or other standard data storage and interface device which stores vehicle and driver data and is used as a vehicle key; and
b. a USB key port/slot (IntelaKey Ignition Switch) which connects to an IntelaKey Processor which connects to a vehicles computer control and monitoring systems, mechanical systems, GPS system, and sensors in the vehicle for collecting vehicle and driver information, reading the vehicle-related data from the vehicles computer system, storing the collected vehicle information on the IntelaKey and for starting the vehicle.
c. A memory in the vehicles key for storing data including vehicle sensor data collected from the control units and sensors throughout the vehicle, driver specific data, security codes, VIN numbers, GPS information, user and time information.
d. an interface micro processor (IntelaKey Processor) and program to determine and relay user settings from the IntelaKey to various vehicle devices and features:
e. A memory, processor and program (IntelaKey Processor) located in the vehicle and attached to the vehicles data bus for managing and collecting the vehicle data to be stored on the IntelaKey.
f. A PC compatible computer program (IntelaKey Software) to store, manipulate, manage and interpret data from an IntelaKey.
g. A key (IntelaKey) which incorporates a USB or other data storage device and collects data from a vehicles IntelaKey Processor.

2. The system claimed in 1, where the IntelaKey has on its surface a fingerprint reader to enhance vehicle security by reading the key's user's fingerprint and comparing it to fingerprint information stored in the IntelaKey Processor ensuring the user is authorized to use the vehicle.

3. The system claimed in 1, where the IntelaKey has on its surface transmitter buttons to start the vehicle, unlock doors and set comfort features.

4. The system claimed in 1 where the IntelaKey includes an LED to indicate that the IntelaKey system is operating and if a vehicle is having mechanical trouble.

5. The method as claimed in claim 1 through 4, where the step for authenticating the IntelaKey is performed by comparing whether an authentication VIN number of the IntelaKey is the same as the VIN number of the vehicle, the user definable security code and the definable vehicle security code are the same as those recorded in the vehicles computer.

6. The system claimed in 1, where the IntelaKey must be inserted in the IntelaKey Ignition Switch to drive the vehicle.

7. The system claimed in 1 where all sensors regarding auto performance including but not limited to speed, rpm's oil pressure, tire pressure, emissions, transmission temperature and all other sensor data are read and stored by the IntelaKey Processor and recorded on the IntelaKey.

8. The system claimed in 1 where parts and fluid service records are stored including auto service dates, parts used with part numbers and shop records for vehicle maintenance on both the IntelaKey and the IntelaKey Processor.

9. A method claimed in 7 where performance data stored on the IntelaKey specific to a user changes the performance settings for a vehicle.

10. The system claimed in 1 and 9 where the software is a vehicle diagnostic tool run on a PC or network which uses data stored on an IntelaKey or IntelaKeys and displays maintenance requirements and information based on diagnostic results on a PC monitor.

11. A method as described in 9 that includes a USB docking station (IntelaKey Docking Station) that holds, monitors user access and IntelaKey use and uploads data from multiple IntelaKeys to a PC or computer network.

12. The system claimed in 1 through 4 and 6 though 9 where all information may be stored for multiple vehicles and recorded on one IntelaKey allowing that IntelaKey to operate multiple vehicles.

13. The system as claimed in 1 through 4 and 6 through 8 where the software includes:
a. a database containing acceptable operating and diagnostic parameters to compare to the IntelaKey data; and
b. A reporting system in the software that makes recommendations on actions to be taken to maintain the vehicle at optimum performance levels.
c. A time, date, GPS and mapping data analysis method that reports times, routes and layovers for vehicles.

14. The method claimed in 1 and 8 where the vehicles computer collects output signals from vehicle speed sensors, injectors, brakes, and electronic sensors including time and date, driving states, driver's characteristics and updates to current trip information and stores them on the IntelaKey.

15. The system claimed in 1 where the information on the IntelaKey may include purchase date, vehicle owner's name, residence, telephone numbers, registration number, driver's license number and email address.

16. The system claimed in 14 where sensors monitoring driving style including but not limited to speed, rpm's, G-force, distance from other vehicles and braking speed sensor data are read and stored by the IntelaKey Processor and recorded on the IntelaKey as values change and then is compared to preset standards to determine the drivers driving style.

17. The system claimed in 9 and 14 through 16, where the IntelaKey Processor includes a program that interprets signals from, but not limited to these sensors, the vehicles speedometer, injectors, fuel pump, throttle valve position sensors, air volume sensors, temperature sensors, air intake sensors and exhaust sensors and transfers the signals to the IntelaKey Processor.

18. A method claimed in 1 to automatically change convenience and performance settings inside a vehicle by using an IntelaKey or with radio transmission button located on the IntelaKey:
a. checking if an IntelaKey is inserted in the IntelaKey ignition position;
b. reading the comfort settings from the IntelaKey and loading the settings stored in the IntelaKey on the vehicles user feature controller;
c. loading comfort and performance settings based on radio transmission of the users identification;
d. monitoring comfort setting changes and if the comfort settings are changed, detecting and storing the changes if confirmed by the key holder; and
e. Loading new comfort setting to the IntelaKey.

19. The system claimed in 1 where there is a key hole/USB data port for reading the vehicle data and user data from the IntelaKey to the vehicle's Intelakey Processor and transferring vehicle data stored on the vehicle's IntelaKey Processor to the IntelaKey through the IntelaKey Ignition Switch.

20. The system as claimed in 1 through 8, 13, 14, 17, and 19 where all IntelaKey data collected on an IntelaKey may be transmitted over the airways via radio, cell phone or other transmission wave.

21. The system claimed in 1 where the vehicle data on the IntelaKey and IntelaKey Processor includes information about the particular vehicle including performance settings and its owner/driver including fingerprint data, user passwords, digital combinations, codes and other security data, vehicle maintenance data gathered from the vehicles computers and sensors, GPS data and maps, and date and time data.

22. The system claimed in 1 where software and hardware includes:
a a USB port on a PC and software compatible with all major PC operating systems for reading the vehicle-related data from the IntelaKey and for storing certain processed vehicle-related data in the IntelaKey; and
b. A data processing means for outputting all the diagnostic information and maintenance items from the vehicles main computer to the IntelaKey and from the IntelaKey to a PC and then using the IntelaKey Software or other compatible software and manufacturers diagnostic codes to output maintenance recommendations.

23. The method claimed in any of claims 9, 17 and 22 where the IntelaKey works multiple vehicles by storing multiple VIN numbers and user passwords, vehicle security codes, vehicle maintenance records and requirements and other vehicle databases.

24. The system claimed in 1 where the vehicle interface includes:
a. A vehicle interface (IntelaKey Processor) connecting multiple vehicle diagnostic processors and sensors and the IntelaKey Processor to the ignition slot;
b. a sensor interface for formatting and transferring vehicle sensor output values to the IntelaKey Processor; and
c. a data input interface for relaying and changing feature setting stored in the IntelaKey to all user devices such as seat settings, mirror settings, radio station settings, performance settings and temperature settings.
d. A method to change a vehicle's performance settings such as torque, horse power, fuel efficiency and top speed.

25. A fleet management PC interface and software which stores, holds and monitors multiple IntelaKeys for time and use data providing manager notification alarms based on programmed parameters.

26. The system claimed in 10 where IntelaKey data may be transferred from a PC, a network, either intranet or internet, and deliver the raw IntelaKey data to another computer which has the IntelaKey Software to analyze, store and report on the data.

27. The system as claimed in 25 and 26 where the software also stores all historical information to assist with diagnosis of any maintenance issues that arise from the IntelaKey Processor, The IntelaKey and the PC or network hosting the IntelaKey Software.

28. A method in which vehicle-related information is stored on the IntelaKey by collecting data from control units, computers and sensors inside a vehicle and then transfers commands to the respective control units inside the vehicle and receives responses to self diagnostic requests and for changing performance settings for carburetors, fuel pumps and ignition.

29. Executing a vehicle diagnosis program on a PC using IntelaKey Data.

30. Reading the vehicle-related data stored in the authenticated IntelaKey.

31. Running the diagnostics program, reading vehicle-related data and performing vehicle diagnosis; and displaying the diagnostic results on a PC monitor using IntelaKey Data.

32. A method for diagnosing a vehicle by using the data stored on the IntelaKey including the information collected through any of 7, comprising steps of:
a. inserting the IntelaKey in the ignition port;
b. connecting the IntelaKey to a PC or through a network and authenticating whether the IntelaKey controlled vehicle needs to be serviced by a service provider who is using a PC and IntelaKey Data compatible software.
c. transferring the collected vehicle-related data from the IntelaKey to the PC if the IntelaKey is authenticated;
d. diagnosing the vehicle based on the collected vehicle-related data and storing the diagnostic results; and
e. Transferring the diagnostic results to a terminal, displaying the results on the terminal, and storing the results in the IntelaKey.

33. A method to use the digital radio as a number code system for entering combinations, as in a combination lock, to allow an authorized driver to engage the transmission.
